(19) United States
(12) Patent Application Publication
(10) Pub. No.: US 2016/0013933 A1
(43) Pub. Date: Jan. 14, 2016

(54) ORDER-PRESERVING ENCRYPTION SYSTEM, DEVICE, METHOD, AND PROGRAM

(71) Applicant: NEC CORPORATION, Tokyo (JP)

(72) Inventor: Isamu TERANISHI, Tokyo (JP)

(73) Assignee: NEC CORPORATION, Tokyo (JP)

(21) Appl. No.: 14/770,692

(22) PCT Filed: Jan. 27, 2014
(86) PCT No.: PCT/JP2014/000378

§ 371 Date: Aug. 26, 2015

(30) Foreign Application Priority Data
Feb. 28, 2013 (JP) 2013-038238

(51) Int. Cl. H04L 9/06

(52) U.S. Cl. CPC H04L 9/0662

(57) ABSTRACT

This invention allows order-preserving encryption with a simpler algorithm while ensuring security. An order-preserving encryption system includes encryption means 1 for, upon receiving a plaintext as input, generating an order-preserved cipher in accordance with a predetermined probability distribution generated based on values determined from the plaintext and on a set generated from a plaintext space included in a secret key using a uniform distribution, or a key to a predetermined pseudorandom function, the probability distribution representing a conditional probability as a binomial distribution.

### TECHNICAL FIELD

The present invention relates to an order-preserving encryption system, an encryption device, a database system, an order-preserving encryption method and an order-preserving encryption program.

### BACKGROUND ART

Encryption techniques are employed to ensure data confidentiality in communication. However, keeping the data completely confidential does not always lead to high usability for practical applications. Rather, keeping the data confidential too much may degrade the usability.

Keeping the data confidential too much degrades the usability when, for example, the sizes of two numerical data are to be compared.

To improve the usability while keeping the data confidential, techniques described in, for example, NPL 1 and PTL 1 are available. Both of these techniques use an encryption scheme called order-preserving encryption.

### CITATION LIST

### [Patent Literature]

[PTL 1] Pamphlet of International Publication No. WO 2012/157279

### [Non Patent Literature]

[NPL 1] Alexandra Boldyreva, Nathan Chenette, Younho Lee and Adam O'Neill, “Order-Preserving Symmetric Encryption.”, EUROCRYPT 2009, pp. 224-241.

### SUMMARY OF INVENTION

### Technical Problem

As long as two data m and m′ can be read directly, the sizes of m and m′ can be compared. However, when m and m′ are stored as encrypted by an encryption scheme such as AES (Advanced Encryption Standard) or DES (Data Encryption Standard), the sizes of m and m′ cannot be compared even by reading the cyphers.

The above-mentioned case may be serious especially in a secure database for the following reason. In the secure database, since directly storing plaintexts in the database is undesirable due to concerns for security, the plaintexts must be stored upon encryption, and a comparison between the sizes of data is naturally required in the database. In addition, since encryption is useless when keys to the ciphers are stored in the same database, the keys are usually stored in different locations. In this way, in the secure database, it is necessary to process data encrypted in the absence of keys. Even if keys are available, since the database stores a large number of data, it is inefficient in practice to decrypt all these data and compare their sizes.

With the recent development of cloud computing technology, users are expected to store their own data in databases on the cloud more frequently than before. Therefore, it is highly probable that techniques for comparing the sizes of data stored in the databases as encrypted will be very important in the future.

Order-preserving encryption allows comparison of encrypted documents in size of plaintexts. With this encryption scheme, when the plaintexts m and m′ satisfy m<m′, their cyphers Enc_m and Enc_m′ also satisfy Enc_m<Enc_m′.

When the data is encrypted using the order-preserving encryption scheme, checking whether Enc_m<Enc_m′ specifies the larger of the plaintexts m and m′ without decrypting the cyphers Enc_m and Enc_m′.

As is also agreed by the authors of NPL 1, the scheme described in NPL 1 provides imperfect considerations in terms of security, and its practical application is hampered by this fact.

The scheme described in PTL 1 solves this problem. However, the scheme described in PTL 1 is unsuitable for implementation due to the complexity of the algorithm used.

In view of this, it is an exemplary object of the present invention to provide an order-preserving encryption system, an encryption device, a database system, an order-preserving encryption method, and an order-preserving encryption program for performing order-preserving encryption with a simpler algorithm while ensuring security.

### Solution to Problem

An order-preserving encryption system according to an aspect of the present invention includes encryption means for, upon receiving a plaintext as input, generating an order-preserved cipher in accordance with a predetermined probability distribution generated based on a value determined from the plaintext and on a set generated from a plaintext space included in a secret key using a uniform distribution, or a key to a predetermined pseudorandom function, the probability distribution representing a conditional probability as a binomial distribution.

An encryption device according to another aspect of the present invention includes encryption means for, upon receiving a plaintext as input, generating an order-preserved cipher in accordance with a predetermined probability distribution generated based on a value determined from the plaintext and on a set generated from a plaintext space included in a secret key using a uniform distribution, or a key to a pseudorandom function, the probability distribution representing a conditional probability as a binomial distribution.

A database system according to still another aspect of the present invention includes encryption means, data storage means, and size comparison means. Upon receiving a plaintext as input, the encryption means generates an order-preserved cipher OPEPart in accordance with a predetermined probability distribution generated based on a value determined from the plaintext and on a set generated from a plaintext space included in a secret key using a uniform distribution, or a key to a pseudorandom function, the probability distribution representing a conditional probability as a binomial distribution. The data storage means stores the cipher OPEPart generated by the encryption means as data. The size comparison means determines a size of a content of the data stored in the data storage means relative to an arbitrary plaintext M. The size comparison means determines a size of the content of the data relative to an arbitrary plaintext M by comparing a size of the data to be determined with a cipher OPEPart_M for the plaintext M having undergone order-preserving encryption by the encryption means.

An order-preserving encryption method according to still another aspect of the present invention includes generating data including a set generated from a plaintext space using a uniform distribution, or a key to a predetermined pseudorandom function to obtain a secret key, and upon receiving a plaintext as input, generating an order-preserved cipher in accordance with a predetermined probability distribution generated based on a value determined from the plaintext and on the set generated from the plaintext space included in the secret key using the uniform distribution, or the key to the predetermined pseudorandom function, the probability distribution representing a conditional probability as a binomial distribution.

An order-preserving encryption program according to still another aspect of the present invention causes a computer to execute processing of, upon receiving a plaintext as input, generating an order-preserved cipher in accordance with a predetermined probability distribution generated based on a value determined from the plaintext and on a set generated from a plaintext space included in a secret key using a uniform distribution, or a key to a pseudorandom function, the probability distribution representing a conditional probability as a binomial distribution.

### Advantageous Effects of Invention

The present invention allows order-preserving encryption with a simpler algorithm while ensuring security. Therefore, the sizes of plaintexts as encrypted can be compared securely and efficiently. Also, such a system, a device, and a program can be easily implemented.

### BRIEF DESCRIPTION OF DRAWINGS

FIG. 1 is a block diagram illustrating an example of a device provided in an order-preserving encryption system according to a first exemplary embodiment.

FIG. 2 is a block diagram illustrating an exemplary configuration of the order-preserving encryption system according to the first exemplary embodiment.

FIG. 3 is a flowchart illustrating exemplary parameter generation processing according to the first exemplary embodiment.

FIG. 4 is a flowchart illustrating exemplary key generation processing according to the first exemplary embodiment.

FIG. 5 is a flowchart illustrating exemplary encryption processing according to the first exemplary embodiment.

FIG. 6 is a flowchart illustrating exemplary parameter generation processing according to a second exemplary embodiment.

FIG. 7 is a flowchart illustrating exemplary key generation processing according to the second exemplary embodiment.

FIG. 8 is a flowchart illustrating exemplary encryption processing according to the second exemplary embodiment.

FIG. 9 is a block diagram illustrating an exemplary configuration of an order-preserving encryption system according to a third exemplary embodiment.

FIG. 10 is a block diagram illustrating another exemplary configuration of the order-preserving encryption system according to the third exemplary embodiment.

FIG. 11 is a flowchart illustrating exemplary key generation processing according to the third exemplary embodiment.

FIG. 12 is a flowchart illustrating exemplary encryption processing according to the third exemplary embodiment.

FIG. 13 is a flowchart illustrating exemplary decryption processing according to the third exemplary embodiment.

FIG. 14 is a block diagram illustrating an exemplary database system to which the order-preserving encryption system is applied.

FIG. 15 is a block diagram illustrating another exemplary database system to which the order-preserving encryption system is applied.

FIG. 16 is a block diagram illustrating an exemplary minimum configuration of the order-preserving encryption system according to the present invention.

FIG. 17 is a block diagram illustrating an exemplary minimum configuration of the database system according to the present invention.

### DESCRIPTION OF EMBODIMENTS

An idea common to the following first to fourth exemplary embodiments will be described first. The order-preserving encryption scheme described in PTL 1 will be briefly described first, and the order-preserving encryption scheme according to the present invention will be described next, in order to explain the differences between the former and the latter. The order-preserving encryption scheme described in PTL 1 will be simply referred to as the scheme of PTL 1 hereinafter.

### (Idea of Scheme of PTL 1)

{1, . . . , N} is a plaintext space. X is a probability distribution that outputs positive values in most cases, and ζ is a constant. For each iε{−ζ, . . . , N}, a cipher for a plaintext mε{1, . . . , N} can be described as:

Enc(K,m)=Σ_{i=-ζ . . . ,m}α[i]

where α[i] is a random number that follows a probability distribution X and can be calculated only by a person who knows a secret key K. To decrypt a cipher C, m that satisfies C=Σ_{i=ζ, . . . , m}α[i] is output as a plaintext. Enc(K, m) is the sum of −ζ to m. In this scheme, on the right-hand side of Enc(K, m)=Σ_{i=-ζ, . . . , m}α[i], the larger m, the larger the number of α[i] added. This means that the larger m, the larger Enc(K, m). Thus, when m<m′, Enc(K, m)<Enc(K, m′) is established.

Although the above-mentioned scheme can be executed for arbitrary X in principle, it is desired to use a distribution showing a larger number of bits with a lower probability in terms of security. As a probability distribution X that satisfies such characteristics, a distribution defined as follows, for example, can be used. Let p[1], . . . , p[U] be nonnegative integers that satisfy p[1]+ . . . +p[U]=1, and n[1], . . . , n[U] also be nonnegative integers. Let D[p[1], . . . , p[U]] be a probability distribution that outputs an integer j defined as j=i with the probability p[i]. Let B[1] be a probability distribution that outputs a nonnegative integer having a bit length equal to or smaller than the length n[1], and B[U] be a probability distribution that outputs a nonnegative integer having a bit length equal to or smaller than the length n[U]. X is defined as a distribution followed by a, which is selected using a method of “selecting an integer j in accordance with D[p[1], . . . , p[U]] and then selecting a in accordance with B[j].” Given the aforementioned definition of X, X outputs a nonnegative integer having a bit length equal to or smaller than the length n[1] with the probability p[1], outputs a nonnegative integer having a bit length n[2] larger than n[1] with the probability p[2], outputs a nonnegative integer having a bit length n[3] larger than n[2] with the probability p[3], . . . . Hence, X satisfies the above-mentioned characteristics as long as p[1], . . . , p[U] and n[1], . . . , n[U] are appropriately selected.

The first exemplary embodiment provides a method of defining the secret key K as K=(α[ζ], . . . , α[N]) and calculating the sum of α[1], . . . , α[m] in encryption to obtain a cipher Enc(K, m)=Σ_{i=-ζ, . . . , m}α[i]. To decrypt the given cipher C, Σ_{i=-ζ, . . . , m}α[i] is calculated for each m to find m that satisfies C=Σ_{i=-ζ, . . . , m}α[i].

In the second exemplary embodiment, the cypher Enc(K, m) for m is Enc(K, m)=Σ_{i=-ζ, . . . , m}α[i], as in the first exemplary embodiment, but a binomial distribution B(τ[j], q) is used in place of the distribution B[j], where τ[1], . . . , τ[U] and q are parameters. The binomial distribution B(k, p′) means a distribution followed by the number of coins that come up heads when k coins that will come up heads with the probability p′ are tossed.

### (Idea of Order-Preserving Encryption Scheme According to Present Invention)

The idea of the order-preserving encryption scheme according to the present invention will be described below. In the present invention, while U real numbers p[1], . . . , p[n] and U probability distributions B[1], . . . , B[n] are used in the first exemplary embodiment described in PTL 1, the scheme is implemented assuming only U=1, and a description thereof will be given below. p[1] and B[1] will be simply referred to as p and B, respectively, without a suffix hereinafter.

In the first exemplary embodiment of the present invention, P is a probability distribution that takes 0 with the probability p and 1 with the probability 1−p. In key generation according to the first exemplary embodiment, variables j[1], . . . , j[n] are selected in accordance with P. α[i] is selected in accordance with B for i that satisfies j[i]=0, and α[i]=1 is set for i that satisfies j[i]=1. In encryption according to the first exemplary embodiment, the sum C of α[i] for a plaintext M or less is calculated.

By definition C is given by:

C=(Σ_{i≦M that satisfies j[i]=0}α[i])+(Σ_{i≦M that satisfies j[i]=1}α[i])

The first and second terms of the right-hand side in this equation are defined as C′ and C″, respectively.

When j[i]=1, α[i]=1. Then, C″ is given by:

C″=(the count of i≦M that satisfies j[i]=1)

In the second exemplary embodiment described in PTL 1, C′ and C″ are efficiently calculated to heighten the calculation efficiency of encryption. To attain this, in the second exemplary embodiment, B is set to a binomial distribution. Since C′ is the sum of values of α[i] that follows a binomial distribution, C′ itself follows a binomial distribution in that case. P is the Bernoulli distribution that is a special binomial distribution. Thus, the above-mentioned equation shows that C″ also follows a binomial distribution.

That is, in the second exemplary embodiment described in PTL 1, these binomial distributions are efficiently calculated based on the bisection method. In this case, the conditional probabilities of the binomial distributions are used. More precisely, C″ and C′ in the second exemplary embodiment described in PTL 1 are calculated using the following conditional probability distributions (a and b are given values):

the probability distribution of “the count of elements that satisfy j[i]=1 for a set {a, . . . , a+b}” under the condition that “the count of elements that satisfy j[i]=0 for the set {a, . . . , a+2b} is n;” and

the probability distribution of “the sum of α[i] that satisfies j[i]=0 for the set {a, . . . , a+b}” under the condition that “the sum of α[i] that satisfies j[i]=0 for the set {a, . . . , a+2b} is m.”

Since these probability distributions are known to be hypergeometric, the hypergeometric distributions are necessary in the second exemplary embodiment described in PTL 1.

In the present invention, as in PTL 1, a basic scheme is generated first and improved to provide a more efficient scheme. These schemes will be respectively described in detail in the first and second exemplary embodiments, while the differences between the scheme of PTL 1 and the order-preserving scheme according to the present invention will be briefly described hereinafter.

The scheme of PTL 1 uses hypergeometric distributions to calculate both C′ and C″, while in the present invention the scheme is improved to obviate the need to use hypergeometric distributions in calculating both C′ and C″.

An idea employed to obviate the need to use a hypergeometric distribution in calculating C″ will be described first. Let {0, . . . , MesSpSize} be a plaintext space and S be a set of i that satisfies j[i]=0. In the scheme of PTL 1, j[i]=0 with the probability p and the expected value of the count of elements in S is therefore MesSpSize/p.

That is, the scheme of PTL 1 uses a probability distribution P that takes 1 with the probability p so that:

(1) elements in S are randomly distributed on {0, . . . , MesSpSize}; and

(2) the count of elements in S is approximately MesSpSize/p. The security of the scheme of PTL 1 is ensured by these characteristics.

In contrast to this, in the first exemplary embodiment of the present invention, elements in S are selected uniformly at random from the plaintext space {0, . . . , MesSpSize}.

That is,

N is set to (a value obtained by rounding 4×MesSpSize/p down to the nearest whole digit),

the random numbers u[1], . . . u[N] are selected uniformly at random from {0, . . . , MesSpSize}, and

S={u[1], . . . u[N]} is set.

As is obvious from the above description,

(1)′ elements in S are randomly distributed on {0, . . . , MesSpSize}, and

(2)′ the count of elements in S is approximately 4×MesSpSize/p.

This means that nearly the same characteristics as in (1) and (2) are provided in (1)′ and (2)′. Thus, the security of this scheme is ensured, as in the scheme of PTL 1. Note that N is defined using 4×MesSpSize/p instead of MesSpSize/p so the parameter size is not too small in round-down to the nearest whole digit.

In this way, when S is generated using a uniform distribution in place of a binomial distribution, the conditional probability is not hypergeometric. When S is actually generated using the above-mentioned method, the above-described conditional probability distribution is given as a binomial distribution:

Binom(n, ½)

and no hypergeometric distribution is therefore necessary, where Binom(n, p) is the probability distribution of the number of coins that come up heads when n independent coins that will come up heads with the probability p are tossed. Since an algorithm that efficiently generates elements even for a huge parameter is known to be available for the binomial distribution, elements can be efficiently generated for parameters (for example, a parameter obtained by raising two to the power of the security parameter) even in the order-preserving encryption scheme according to the present invention.

Summing up the aforementioned ideas, in the order-preserving encryption scheme according to the present invention, satisfying the characteristics described above in (1) and (2) is found to be essential in terms of ensuring the security of the scheme of PTL 1, and a set S is newly, clearly defined. The foregoing also presents an appropriate method of generating a set S for avoiding the problems concerning the hypergeometric distribution. This implies that the conditional probability required when a uniform distribution is used is represented in a binomial distribution. Furthermore, a practicable distribution is selected while avoiding the problems concerning the hypergeometric distribution. That is, regarding only the problems concerning the hypergeometric distribution, a distribution other than the binomial distribution can also be used for the conditional probability. However, the binomial distribution is used for the conditional probability to efficiently generate elements for a huge parameter. To generate a set S, an approach to randomly selecting elements from the entire plaintext space is employed. This approach is greatly different from the sequential approach of PTL 1, in which a set S is generated by sequentially selecting j[i] for i=1, 2, . . . . The former approach is also different from the latter approach algorithmically.

A method of obviating the need to use a hypergeometric distribution in generating C′ will be described below. By definition, C′ is given by:

C′=Σ_{i≦M that satisfies j[i]=0}α[i]

In the scheme of PTL 1, since α[i] follows a binomial distribution, C′ that is the sum of α[i] also follows a binomial distribution. Thus, the conditional probability is represented in a hypergeometric distribution.

The present invention completely changes the way to select C′. The value defined as MaxVal is fixed first. In the first exemplary embodiment of the present invention, C′ is selected in the following way:

a set S is selected in the foregoing way;

uniform random numbers c[1], . . . , c[MaxVal] as a function of S are selected; and

S={u[1], . . . , u[N]} and S″={elements in S for MB or less} are set and the count of elements in a set {i|sεS″ that satisfies c[i]=s} is defined as C′.

Since C′ is based on a uniform distribution, taking C′ in the foregoing way generates a binomial distribution of the conditional probability for the same reason as in C″. Hence, as in C″, C′ can be obtained using a bisection method based on the binomial distribution. In the second exemplary embodiment of the present invention, C′ is efficiently obtained based on such a bisection method.

The above-mentioned alternation has been made to the scheme of PTL 1 to practice the first and second exemplary embodiments of the present invention. However, the “ciphers” in the first and second exemplary embodiments cannot be decrypted as a result of such a alternation. Nevertheless, since this scheme has the property of comparing orders without decrypting ciphers, a decryption operation is not always necessary in an application that requires only this property. Therefore, the first and second exemplary embodiments are also useful.

The third and fourth exemplary embodiments provide schemes that allow decryption by improving the first and second exemplary embodiments, respectively.

Exemplary embodiments will be described more specifically below with reference to the accompanying drawings.

### First Exemplary Embodiment

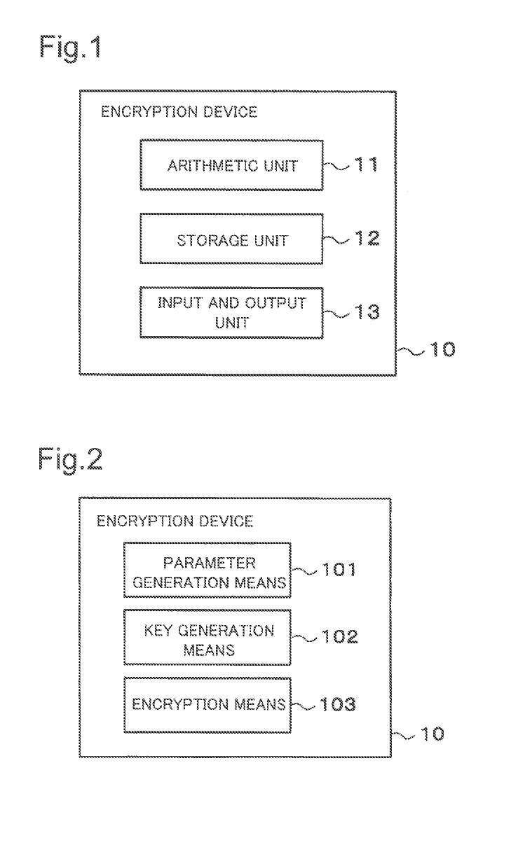

An exemplary configuration of an order-preserving encryption system according to a first exemplary embodiment of the present invention will be described below with reference to FIGS. 1 and 2. FIG. 1 is a block diagram illustrating an example of a device provided in an order-preserving encryption system according to this exemplary embodiment. The order-preserving encryption system according to this exemplary embodiment includes an encryption device 10, as shown in FIG. 1. The encryption device 10 includes an arithmetic unit 11, a storage unit 12, and an input and output unit 13. The encryption device 10 is implemented by, for example, an information processing device such as a personal computer that operates in accordance with a program. In this case, the arithmetic unit 11, the storage unit 12, and the input and output unit 13 are implemented by a CPU, a memory, and various input and output devices (for example, a keyboard, a mouse, and a network interface unit), respectively.

FIG. 2 is a block diagram illustrating an exemplary functional configuration of the order-preserving encryption system according to this exemplary embodiment. The encryption device 10 (more specifically, the arithmetic unit 11 of the encryption device 10) includes parameter generation means 101, key generation means 102, and encryption means 103, as shown in FIG. 2. Each means is implemented by, for example, a CPU that operates in accordance with a program. Although this exemplary embodiment provides an example in which one device includes the parameter generation means 101, the key generation means 102, and the encryption means 103, these types of means may be separately implemented in a plurality of devices.

No decryption means is provided in this exemplary embodiment. A cipher generated by an encryption algorithm according to this exemplary embodiment will be referred to as “OPEPart” hereinafter to distinguish it from a cypher that is decryptable. An encryption algorithm to be described hereinafter includes operations implemented in particular by executing processing in accordance with this algorithm by the CPU of at least one information processing device that implements an order-preserving encryption system.

The parameter generation means 101 calculates a parameter OPEParam required in encryption. The key generation means 102 calculates a secret key OPEKey in response to the parameter OPEParam. The encryption means 103 calculates OPEPart in response to the secret key OPEKey and a plaintext Message.

The procedure of encryption in this exemplary embodiment will be described below.

First, the parameter generation means 101 calculates a parameter OPEParam required in encryption according to this exemplary embodiment. Then, the key generation means 102 calculates a secret key OPEKey using the parameter OPEParam calculated by the parameter generation means 101. The encryption means 103 encrypts a plaintext Message input via the input and output unit 13, using the secret key OPEKey calculated by the key generation means 102, and generates OPEPart as output.

Note that the parameter OPEParam and the secret key OPEkey may be calculated in advance and stored in the storage unit 12.

Processing by each means will be described in detail below. Let MesSpSize be a natural number, {0, . . . , MesSpSize} be a plaintext space, SecPar be a security parameter, k and A be integers indicating measures of security, and a be a real number indicating a measure of security.

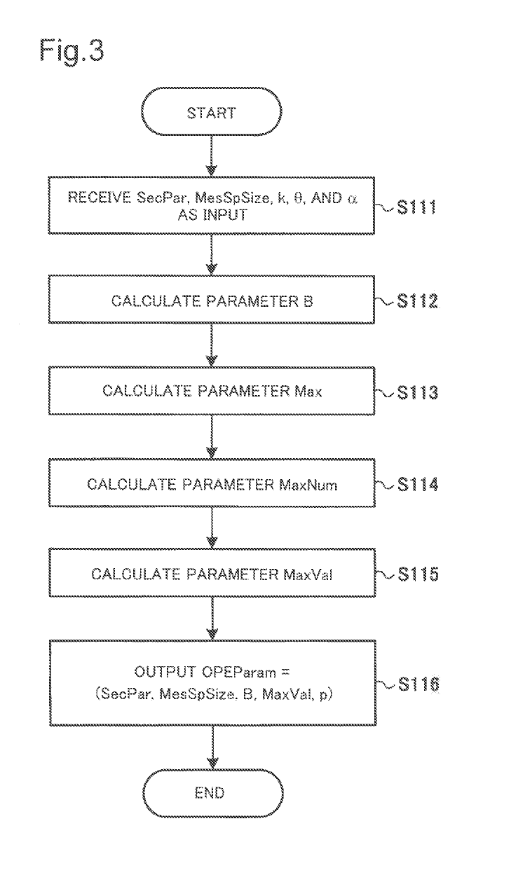

Parameter generation processing executed by the parameter generation means 101 will be described first. FIG. 3 is a flowchart illustrating exemplary parameter generation processing according to the first exemplary embodiment.

In this exemplary embodiment, the parameter generation means 101 executes, for example, the following processing:

the parameter generation means 101 receives SecPar, MesSpSize, k, θ, and a as input (step S111);

the parameter generation means 101 calculates B=kθ+1 (step S112);

the parameter generation means 101 calculates Max=4×MesSpSize (step S113);

the parameter generation means 101 calculates p=θ×kα (step S114);

the parameter generation means 101 calculates MaxNum=(a value obtained by rounding Max/p down to the nearest whole digit) (step S114);

the parameter generation means 101 calculates MaxVal=2^{secPar}×MaxNum (step S115); and

the parameter generation means 101 outputs OPEParam=(SecPar, MesSpSize, B, MaxVal, p) (step S116).

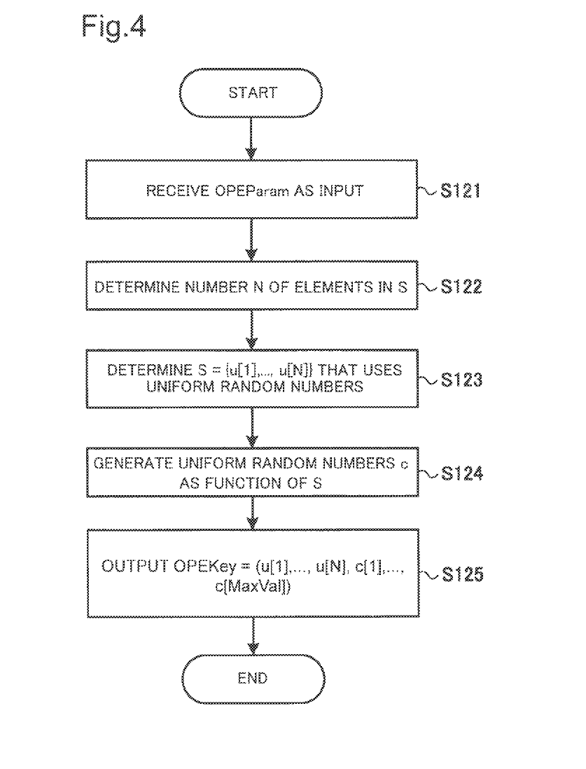

Key generation processing executed by the key generation means 102 will be described next. FIG. 4 is a flowchart illustrating exemplary key generation processing according to the first exemplary embodiment.

In this exemplary embodiment, the key generation means 102 executes, for example, the following processing:

the key generation means 102 receives OPEParam=(SecPar, MesSpSize, B, MaxVal, p) as input (step S121);

the key generation means 102 sets N to (a value obtained by rounding 4×MesSpSize/p down to the nearest whole digit) (step S122);

the key generation means 102 selects random numbers u[1], . . . u[N] uniformly at random from {0, . . . , MesSpSize} to set S={u[1], . . . u[N]} (step S123);

the key generation means 102 selects uniform random numbers c[1], . . . , c[MaxVal] as a function of S (step S124); and

the key generation means 102 outputs OPEKey=(u[1], . . . u[N], c[1], . . . , c[MaxVal]) (step S125).

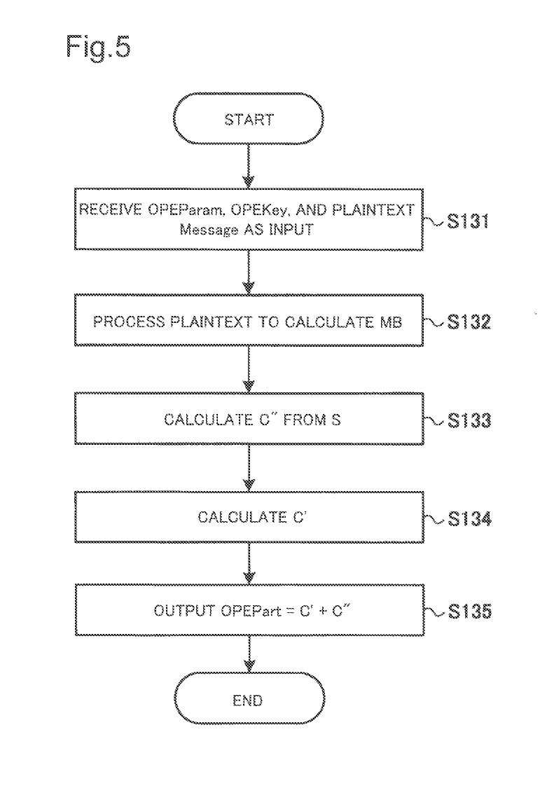

Encryption processing executed by the encryption means 103 will be described next. FIG. 5 is a flowchart illustrating exemplary encryption processing according to the first exemplary embodiment.

In this exemplary embodiment, the encryption means 103 executes, for example, the following processing:

the encryption means 103 receives OPEParam=(SecPar, MesSpSize, B, MaxVal, p), OPEKey=(u[1], . . . u[N], c[1], . . . , c[MaxVal]), and a plaintext Message as input (step S131);

the encryption means 103 calculates MB=Message+B (step S132);

the encryption means 103 sets S={u[1], . . . u[N]} and S″={elements in S for MB or less} and defines the count of elements in a set {i|sεS″ that satisfies c[i]=s} as C″ (step S133);

the encryption means 103 calculates C′=4×MesSpSize−N (step S134); and

the encryption means 103 outputs OPEPart=C′+C″ (step S135).

As described above, the first exemplary embodiment achieves an encryption scheme that can compare the sizes of plaintexts as encrypted, while ensuring security by simpler implementation.

### Second Exemplary Embodiment

A second exemplary embodiment of the present invention will be described below with reference to the accompanying drawings. The device and functional configurations of the second exemplary embodiment are the same as in the first exemplary embodiment. However, in the second exemplary embodiment, a subroutine referred to as PseudoBinom hereinafter is used in encryption processing by encryption means 103.

PseudoBinom( ) is a subroutine that executes the following processing:

a natural number n, bit strings u and v, and a key PRFKey for a pseudorandom function are received as input;

the key PRFKey and an input u∥v are input into the pseudo-random function to obtain an output Q, where u∥v is a concatenation of the bit strings u and v; and

an algorithm that generates random numbers following the binomial distribution Binom(n, ½) is executed to obtain an output R.

In this case, R is used as a random number source for the algorithm.

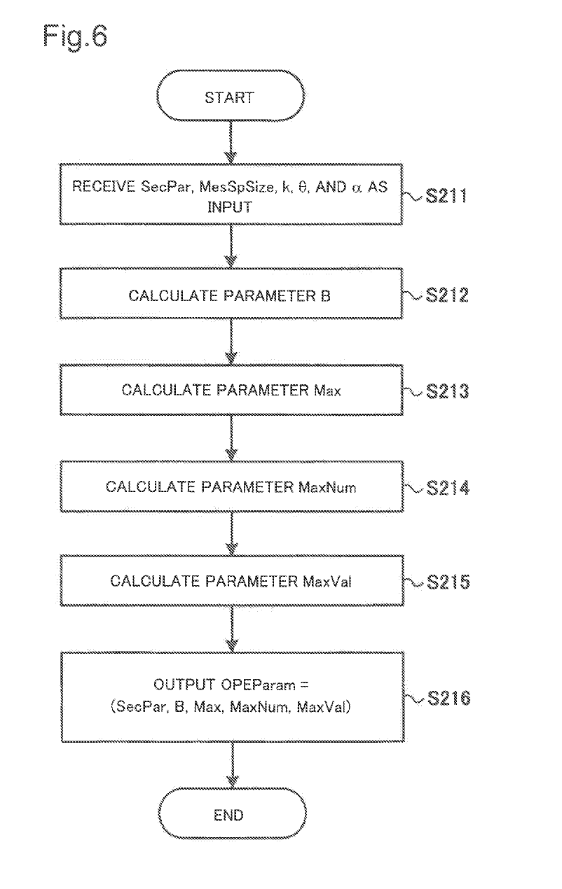

Processing by each means will be described in detail below. Parameter generation processing executed by parameter generation means 101 according to the second exemplary embodiment will be described first. FIG. 6 is a flowchart illustrating exemplary parameter generation processing according to this exemplary embodiment. In this exemplary embodiment as well, let MesSpSize be a natural number, {0, . . . , MesSpSize} be a plaintext space, SecPar be a security parameter, k and θ be integers indicating measures of security, and a be a real number indicating a measure of security.

In this exemplary embodiment, the parameter generation means 101 executes, for example, the following processing:

the parameter generation means 101 receives SecPar, MesSpSize, k, θ, and α as input (step S211);

the parameter generation means 101 calculates B, Max, MaxNum, and MaxVal using the same method as in the first exemplary embodiment (steps S212 to S215); and

the parameter generation means 101 outputs OPEParam=(SecPar, B, Max, MaxNum, MaxVal) (step S216).

The operations in steps S211 to S215 may be the same as in steps S111 to S115 of the first exemplary embodiment.

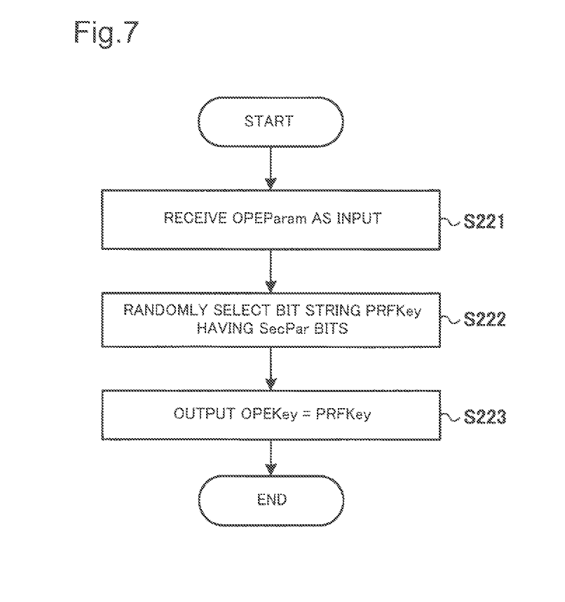

Key generation processing executed by key generation means 102 according to the second exemplary embodiment will be described next. FIG. 7 is a flowchart illustrating exemplary key generation processing according to this exemplary embodiment.

In this exemplary embodiment, the key generation means 102 executes, for example, the following processing:

the key generation means 102 receives OPEParam=(SecPar, B, Max, MaxNum, MaxVal) as input (step S221);

the key generation means 102 randomly selects a bit string PRFKey having SecPar bits (step S222); and

the key generation means 102 outputs OPEKey=PRFKey (step S223).

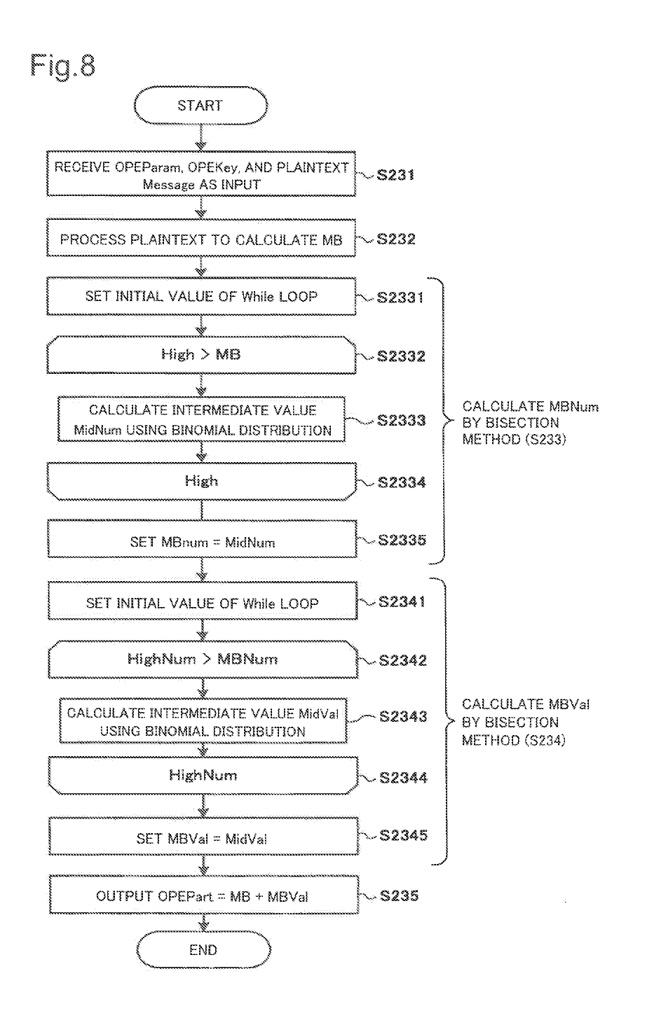

Encryption processing executed by the encryption means 103 according to the second exemplary embodiment will be described next. FIG. 8 is a flowchart illustrating exemplary encryption processing according to this exemplary embodiment.

In this exemplary embodiment, the encryption means 103 executes, for example, the following processing:

the encryption means 103 receives OPEParam=(SecPar, B, Max, MaxNum, MaxVal), OPEKey=PRFKey, and a plaintext Message as input (step S231);

the encryption means 103 calculates MB=Message+B (step S232);

the encryption means 103 calculates (High, Low, HighNum, LowNum)=(Max, 0, MaxNum, 0) as the initial value of a While loop (step S2331);

the encryption means 103 executes the following procedures in (1) through (3) while High>MB (first While loop: steps S2332 to S2334):

(1) Mid=(a value obtained by rounding (Low+High)/2 down to the nearest whole digit) is set (step S2333);
(2) MidNum=LowNum+PseudoBinom(HighNum−LowNum, High, Low, PRFKey) is calculated (step S2333); and
(3) if Mid≧MB, (High, HighNum)=(Mid, MidNum) is set; otherwise, (Low, LowNum)=(Mid, MidNum) is set (step S2333);

the encryption means 103 sets MBNum=MidNum (step S2335);

the encryption means 103 calculates (HighNum, LowNum, HighVal, LowVal)=(MaxNum, 0, MaxVal, 0) as the initial value of a second While loop (step S2341);

the encryption means 103 executes the following procedures in (1) through (3) while HighNum>MBNum (second While loop: steps S2342 to S2344):

(1) MidNum=(a value obtained by rounding (LowNum+HighNum)/2 down to the nearest whole digit) is set (step S2343);
(2) MidVal=LowVal+PseudoBinom(HighVal−LowVal, High, Low, PRFKey) is calculated (step S2343); and
(3) if MidNum MBNum, (HighNum, HighVal)=(MidNum, MidVal) is set; otherwise, (LowNum, LowVal)=(MidNum, MidVal) is set (step S2343);

the encryption means 103 sets MBVal=MidVal (step S2345); and

the encryption means 103 outputs OPEPart=MB+MBVal (step S235).

The above-mentioned encryption processing is structured as follows:

MBNum is calculated based on one bisection method (steps S2331 to S2335); and

MBVal is further calculated based on another bisection method using the obtained NBNum (steps S2341 to S2345).

As described above, the encryption processing by the encryption means 103 in the second exemplary embodiment is implemented by improving the encryption processing by the encryption means 103 in the first exemplary embodiment, using the bisection method to achieve a speedup. The above-mentioned two bisection methods correspond to calculation of S″ in the procedure of the first exemplary embodiment (step S133 in FIG. 5) and calculation of the count C″ of elements in {i|sεS″ that satisfies c[i]=s}. The second bisection method (steps S2341 to S2345) can be activated only when NBNum that is the output of the first bisection method (steps S2331 to S2335) is obtained. In this scheme, therefore, the two bisection methods cannot be executed simultaneously. In this respect, the scheme of this exemplary embodiment is different from the scheme of PTL 1 in which the bisection method is executed only once.

### Third Exemplary Embodiment

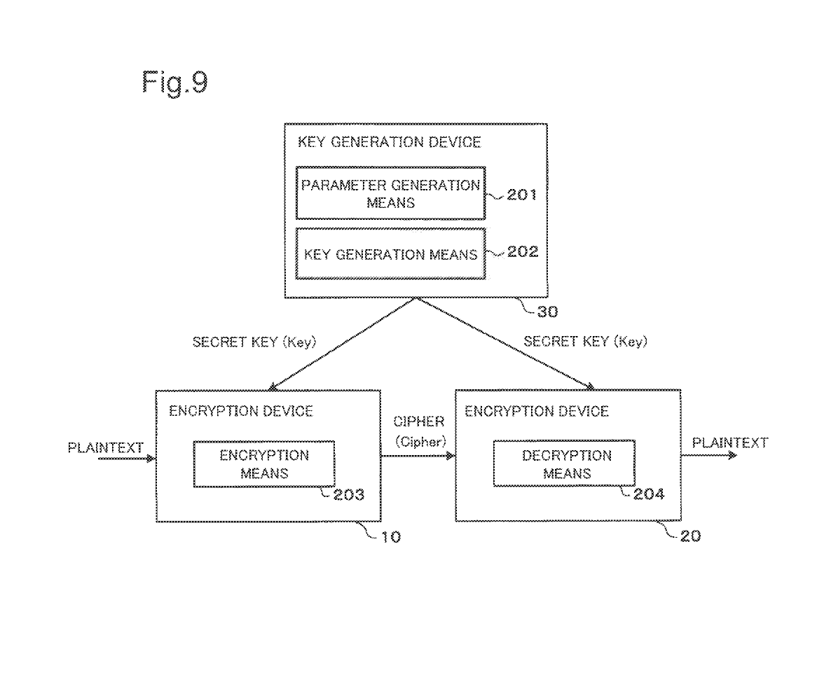

A third exemplary embodiment of the present invention will be described below with reference to the accompanying drawings. FIG. 9 is a block diagram illustrating an exemplary configuration of an order-preserving encryption system according to the third exemplary embodiment. The order-preserving encryption system shown in FIG. 9 includes an encryption device 10, a decryption device 20, and a key generation device 30. Each device has the same physical configuration as that of the encryption device 10 shown in FIG. 1.

In the example illustrated in FIG. 9, the encryption device 10 includes encryption means 203, the decryption device 20 includes decryption means 204, and the key generation device 30 includes parameter generation means 201 and key generation means 202. However, one device may include all these types of means or both the encryption means 203 and the decryption means 204. Again, in the example illustrated in FIG. 9, the key generation device 30 is provided separately from the encryption device 10 and the decryption device 20 and includes the parameter generation means 201 and the key generation means 202. However, the present invention is not limited to this example, and the parameter generation means 201 and/or the key generation means 202 may be included in the encryption device 10, the decryption device 20, or a third device different from the former devices.

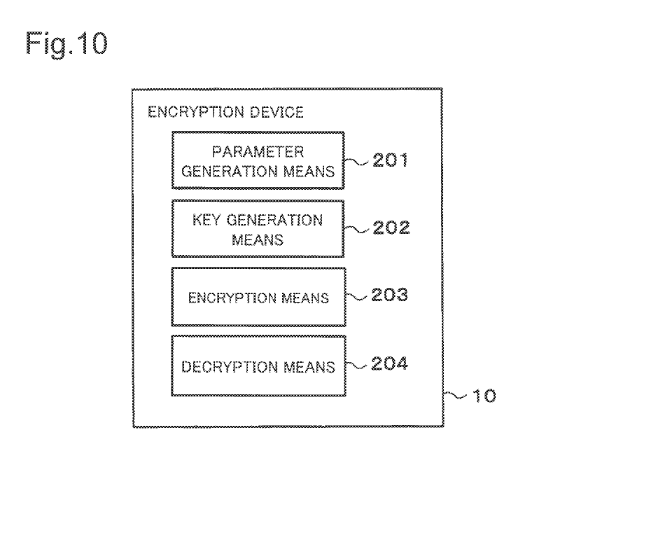

FIG. 10 is a block diagram illustrating another exemplary configuration of the order-preserving encryption system according to the third exemplary embodiment. The encryption device 10 may include the parameter generation means 201, the key generation means 202, the encryption means 203, and the decryption means 204, as shown in, for example, FIG. 10.

Unlike the first and second exemplary embodiments, the third exemplary embodiment provides the decryption means 204. A cipher generated by an encryption algorithm according to the third exemplary embodiment will be referred to as a “cipher text Cipher” hereinafter to distinguish it from the ciphers in the first and second exemplary embodiments. Encryption and decryption algorithms to be described hereinafter include operations implemented in particular by executing processing in accordance with these algorithms by the CPU of at least one information processing device that implements an order-preserving encryption system.

In this exemplary embodiment, the parameter generation means 201 calculates a parameter Param required in encryption and decryption. The key generation means 202 calculates a secret key Key in response to the parameter Param. The encryption means 203 calculates a cipher text Cipher in response to the secret key Key and a plaintext Message.

The decryption means 204 outputs a plaintext Message or a character string indicating that the cipher text Cipher is invalid, in response to the secret key Key and the cipher text Cipher.

The procedure of encryption in this exemplary embodiment will be described below.

First, the parameter generation means 201 calculates a parameter Param required in encryption and decryption according to this exemplary embodiment. Then, the key generation means 202 calculates a secret key Key using the parameter Param calculated by the parameter generation means 201. The encryption means 203 encrypts a plaintext Message input via an input and output unit 13 of the encryption device 10, using the secret key Key calculated by the key generation means 202, and generates a cipher text Cipher as output.

Note that the parameter Param and the secret key Key may be calculated in advance and stored in a storage unit 12 of the encryption device.

The procedure of decryption in this exemplary embodiment will be describe below.

The decryption device 20 receives a cipher text Cipher via, for example, the input and output unit 13. Upon receiving the cipher text Cipher, the decryption means 204 decrypts the cipher text Cipher, using the secret key Key calculated by the key generation means 202, and generates a plaintext Message or a character string indicating that the cipher text Cipher is invalid, as output.

Note that the secret key Key may be stored in the storage unit 12 of the decryption device in advance.

Processing by each means will be described in detail below. Let MesSpSize be a natural number, {0, . . . , MesSpSize} be a plaintext space, SecPar be a security parameter, k and θ be integers indicating measures of security, and α be a real number indicating a measure of security.

SymEnc(SymKey, M) indicates hereinafter that a document M is encrypted using SymKey as a secret key by symmetric-key cryptography. SymDec(SymKey, C) indicates that a cipher C is decrypted using SymKey as a secret key by symmetric-key cryptography.

MAC(MACKey, M) indicates an operation of calculating a message authenticator for the document M using a key MACKey. Ver(MaCKey, M, MAC) indicates an operation of checking whether MAC is the message authenticator of the document M, using the key MACKey. The message authenticator is also called a message authentication code. The method of generating a message authenticator is not particularly limited as long as the message authenticator allows a verifying person having MACKey as a symmetric key to detect a change in content of the document M and protect the integrity of the document M and its authentication. Any existing methods can be adopted to generate a message authenticator and to check validity. In the following example, if input MAC is the message authenticator of the document M, “accept” is returned; otherwise, a value other than “accept” is returned.

Parameter generation processing executed by the parameter generation means 201 will be described first. The processing executed by the parameter generation means 201 is the same as in the parameter generation means 101 according to the first exemplary embodiment. However, in step S116 of FIG. 3, Param=(SecPar, MesSpSize, B, MaxVal) is output.

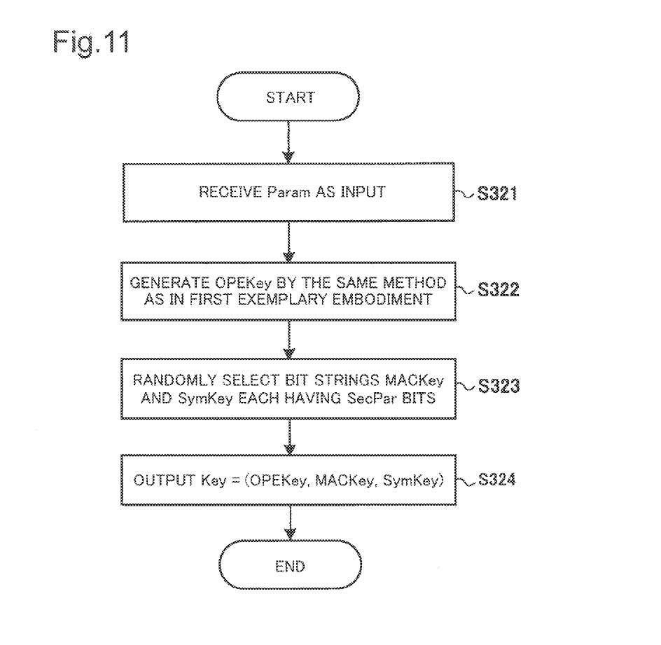

Key generation processing executed by the key generation means 202 will be described next. FIG. 11 is a flowchart illustrating exemplary key generation processing according to the third exemplary embodiment.

The key generation means 202 according to this exemplary embodiment executes, for example, the following processing:

the key generation means 202 receives Param=(SecPar, MesSpSize, B, MaxVal) as input (step S321);

the key generation means 202 generates OPEkey by the same method as in the key generation means 102 according to the first exemplary embodiment, using Param as OPEParam (step S322),

in which steps S122 to S125 in FIG. 4 are executed to obtain OPEKey=(u[1], . . . , u[N], c[1], . . . , c[MaxVal]);

the key generation means 202 randomly selects bit strings MACKey and SymKey having SecPar bits (step S323); and

the key generation means 202 outputs Key=(OPEKey, MACKey, SymKey) (step S324).

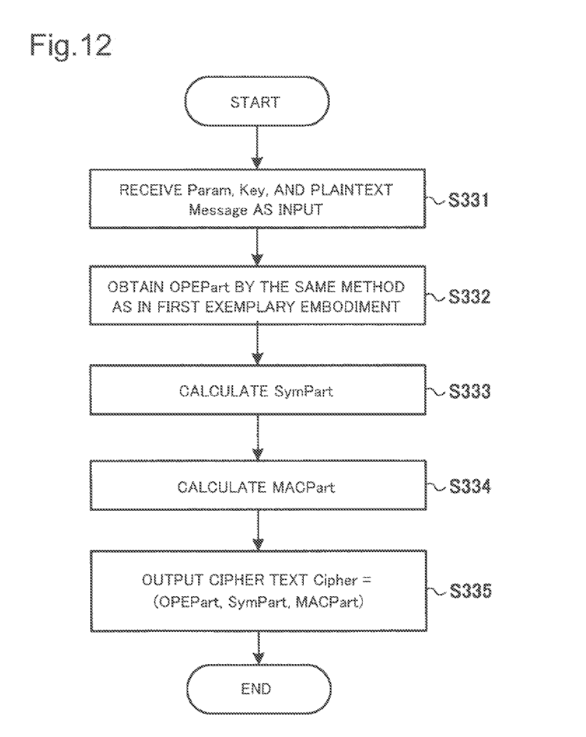

Encryption processing executed by the encryption means 203 will be described next. FIG. 12 is a flowchart illustrating exemplary encryption processing according to the third exemplary embodiment.

In this exemplary embodiment, the encryption means 203 executes, for example, the following processing:

the encryption means 203 receives Param, Key=(OPEKey, MACKey, SymKey) and a plaintext Message as input (step S331);

the encryption means 203 generates OPEPart by the same method as in the encryption means 103 according to the first exemplary embodiment, using Param as OPEParam (step S332),

in which steps S132 to S135 in FIG. 5 are executed to obtain OPEPart=C′+C″;

the encryption means 203 calculates SymPart=SymEnc(SymKey, Message) (step S333);

the encryption means 203 calculates MACPart=MAC(MACKey, OPEPart∥SymPart) (step S334),

where OPEPart∥SymPart is a concatenation of OPEPart and SymPart; and

the encryption means 203 outputs a cipher text Cipher=(OPEPart, SymPart, MACPart) (step S335).

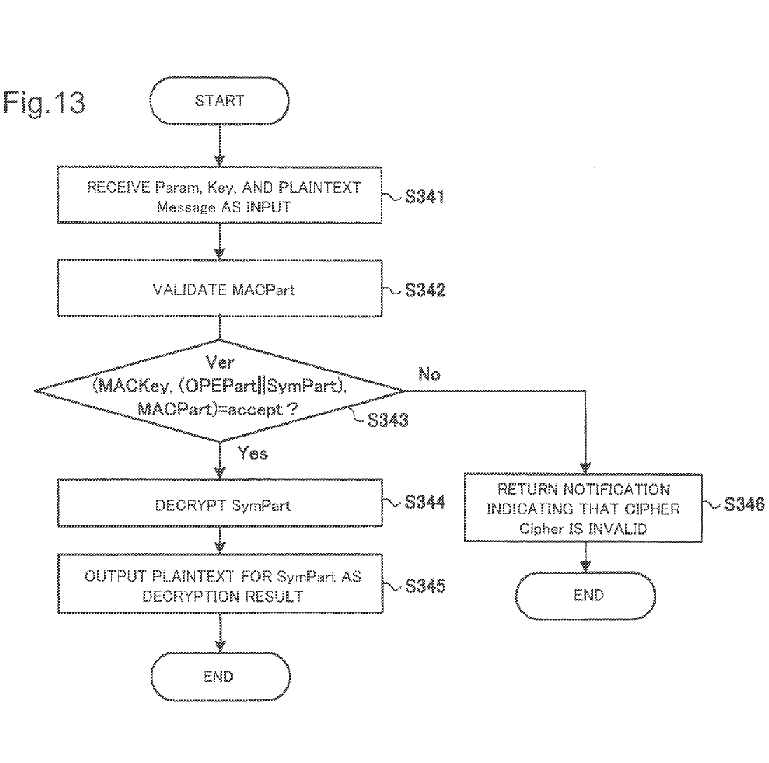

Decryption processing executed by the decryption means 204 will be described next. FIG. 13 is a flowchart illustrating exemplary decryption processing according to the third exemplary embodiment.

In this exemplary embodiment, the decryption means 204 executes, for example, the following processing:

the decryption means 204 receives Param, Key=(OPEKey, MACKey, SymKey), and Cipher=(OPEPart, SymPart, MACPart) as input (step S341);

the decryption means 204 calculates Ver(MACKey, OPEPart∥SymPart, MACPart) (step S342);

if Ver(MACKey, OPEPart∥SymPart, MACPart) # accept, the decryption means 204 returns an output indicating that the input cipher text Cipher is invalid and ends the process (No in step S343 and step S346);

if Ver(MACKey, OPEPartHSymPart, MACPart)=accept, the decryption means 204 calculates Message=SymDec(SymKey, SymPart) (Yes in step S343 and step S344); and

the decryption means 204 outputs Message as a decryption result (step S345).

In this exemplary embodiment, OPEKey is generated together with the generation of a symmetric-key cryptography key SymKey and a key MACKey for a message authenticator. In encryption processing, OPEPart is generated for a plaintext message and a cipher SymPart is also generated by encrypting the plaintext message using a symmetric key SymKey. A message authenticator MACPart is added to a concatenation of the ciphers SymPart and OPEPart using MACKey to obtain a cipher text Cipher. In decryption processing, first, the ciphers SymPart and OPEPart and the message authenticator MACPart are reconstructed from the input cipher text Cipher. The validity of the message authenticator MACPart is checked for a concatenated message of the obtained ciphers SymPart and OPEPart. If the message authenticator MACPart is determined to be valid, the cipher SymPart is decrypted using the symmetric key SymKey to obtain a plaintext.

As described above, in the third exemplary embodiment, a combination of the order-preserving encryption scheme and the symmetric-key cryptography scheme enables decryption. That is, this exemplary embodiment achieves an encryption scheme that can compare the sizes of plaintexts as encrypted in a ready-to-decrypt state, while ensuring security by simpler implementation.

### Fourth Exemplary Embodiment

The fourth exemplary embodiment is practiced by substituting the configuration of the “first exemplary embodiment” in the third exemplary embodiment into that of the “second exemplary embodiment.” That is, parts of the configuration and its operations in the third exemplary embodiment, which are the same as in the first exemplary embodiment, are changed to be the same as in the second exemplary embodiment. Hence, the fourth exemplary embodiment allows encryption processing and decryption processing more efficiently than the third exemplary embodiment.

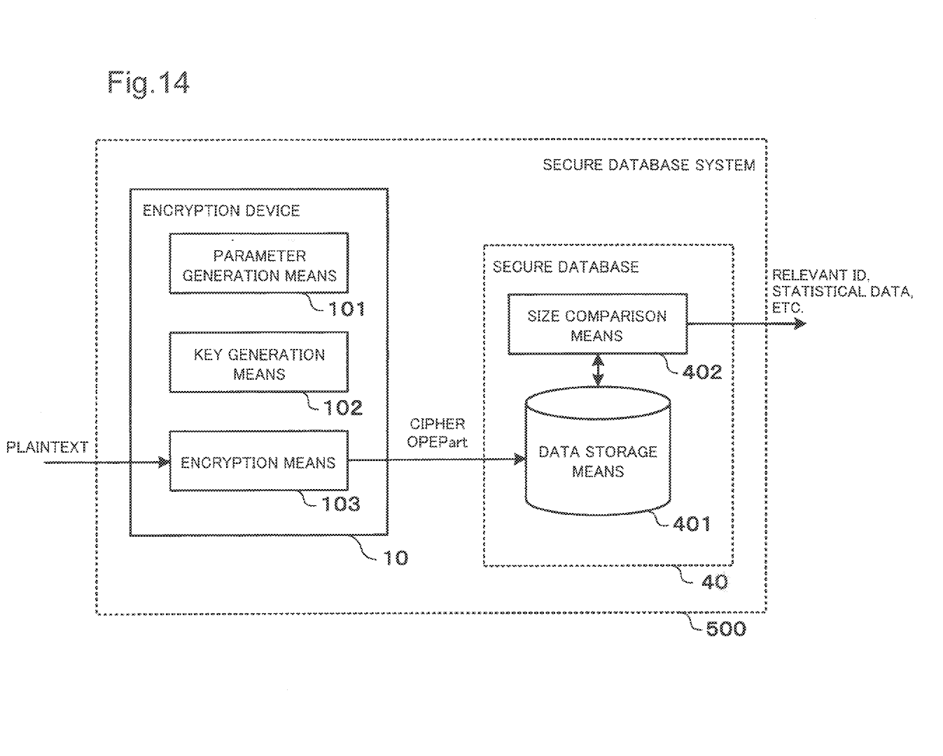

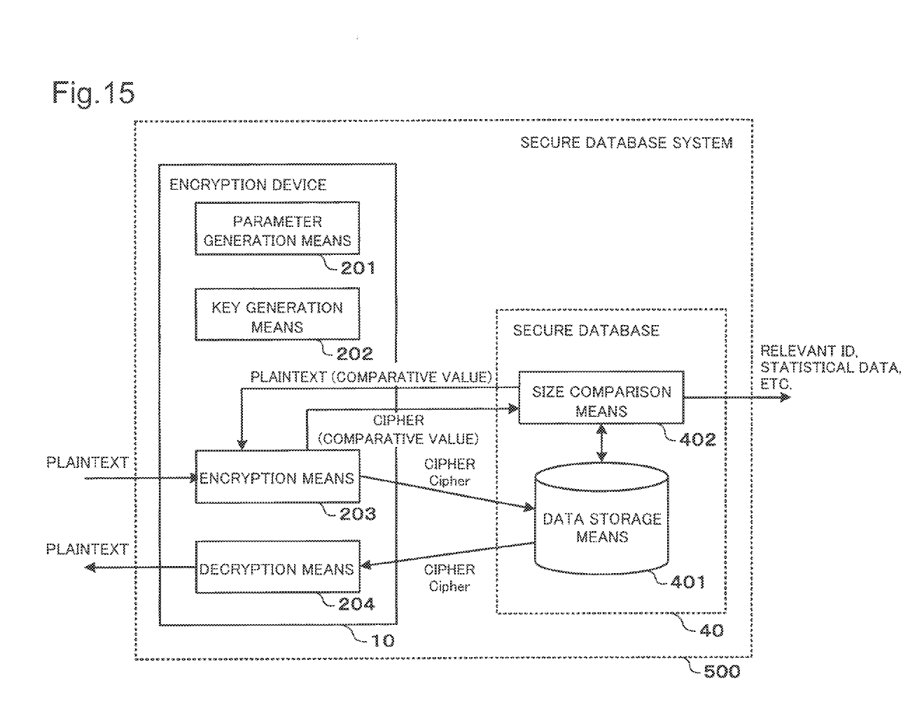

An exemplary secure database system to which the order-preserving encryption system according to the present invention is applied will be described below. FIGS. 14 and 15 are block diagrams illustrating exemplary database systems to which the order-preserving encryption system according to the present invention is applied. In the example shown in FIG. 14, an order-preserving encryption system included in a secure database system 500 includes an encryption device 10 that executes the encryption scheme according to the first exemplary embodiment. In the example shown in FIG. 15, another order-preserving encryption system included in another secure database system 500 includes an encryption device 10 that executes the encryption and decryption schemes according to the third exemplary embodiment.

An exemplary secure database to which the present invention is applied will be described first with reference to FIG. 14. The secure database system 500 shown in FIG. 14 includes an encryption device 10 that executes the encryption scheme according to the first exemplary embodiment, and a secure database 40. The secure database 40 includes data storage means 401 for storing data, a controller (not shown) that systematically operates the data in the database, and size comparison means 402 that implements one function of the controller. The encryption device 10 in this exemplary embodiment encrypts the data held in the secure database 40.

In the encryption device 10, parameter generation means 101 and key generation means 102 execute parameter generation processing and key generation processing in advance (for example, before the use of the secure database 40) to generate OPEParam and OPEkey, respectively.

Assume, for example, that Message[1], . . . , Message[n] are input from the user who uses the encryption device 10 (or any program installed on the encryption device 10) to the encryption device 10 as messages to be registered in the secure database 40. Upon receiving such messages Message[1], . . . , Message[n], encryption means 103 may encrypt each message Message to calculate outputs OPEPart[1], . . . , OPEPart[n] and send them to the secure database 40. If, for example, encryption processing by the encryption means 103 is implemented as OPEPartGen(OPEParam, Message), OPEPartGen(OPEParam, Message[1]), . . . , OPEPartGen(OPEParam, Message[n]) are executed to obtain outputs OPEPart[1], . . . , OPEPart[n], respectively.

The secure database 40 stores the received data in the data storage means 401. In this exemplary embodiment, each OPEPart is stored in the format of (i, OPEPart[i]). That is, the secure database 40 stores (1, OPEPart[1]), . . . , (n, OPEPart[n]) in the data storage means 401. A suffix i to OPEPart[i] will be referred to as the ID of OPEPart[i] or Message[i] hereinafter.

Assume, for example, that the user who uses the encryption device 10 (or any program installed on the encryption device 10) requires the IDs of messages having values of M (inclusive) to M′ (inclusive) of the messages Message[ ] stored in the secure database 40. In such a case, the encryption device 10 calculates OPEPart_M=OPEPartGen(OPEParam, M) and OPEPart_M′=OPEPartGen(OPEParam, M′) and send OPEPart_M and OPEPart_M′ to the secure database 40 as data to be compared.

The size comparison means 402 of the secure database 40 outputs a list List of i that satisfies OPEPart_M≦OPEPart[i]≦OPEPart_M′ from OPEPart[1] through OPEPart[n], as a retrieval result.

Because of the property of order-preserving encryption, the necessary and sufficient condition to satisfy M≦Message[i]≦M′ is given by OPEPart_M≦OPEPart[i]≦OPEPart_M′. Hence, a list of i that satisfies OPEPart_M≦OPEPart[i]≦OPEPart_M′ can be obtained by executing the above-mentioned protocol.

The above-mentioned protocol is useful in, for example, the following situation: the encryption device 10 stores a list of members of any application and their IDs and the age of a member having ID=i is Message[i]. In such a case, when the above-mentioned comparison processing is performed for, for example, M=20 and M′=29, a list of i that satisfies M≦Message[i]≦M′, that is, a list of the IDs of members in their twenties can be obtained. Based on this list, the number of members in their twenties can be determined. Based further on the obtained information, statistical processing can be performed or the names of members in their twenties or the like can be obtained from, for example, another member database associated by the IDs.

If only the number is required, the size comparison means 402 of the secure database 40 may output the count of i that satisfies OPEPart_M≦OPEPart[i]≦OPEPart_M′, as a retrieval result.

When the encryption device 10 is implemented to execute the encryption scheme according to the second exemplary embodiment, encryption processing can be more efficiently performed.

Another exemplary secure database to which the present invention is applied will be described next with reference to FIG. 15. FIG. 15 illustrates an exemplary database system to which the order-preserving encryption system according to the third exemplary embodiment is applied. The secure database system 500 shown in FIG. 15 includes an encryption device 10 that executes the encryption and decryption schemes according to the third exemplary embodiment, and a secure database 40. The secure database 40 includes data storage means 401 for storing data, a controller (not shown) that systematically operates the data in the database, and size comparison means 402 that implements one function of the controller. The encryption device 10 in this exemplary embodiment encrypts and decrypts the data held in the secure database 40.

In the encryption device 10, parameter generation means 201 and key generation means 202 execute parameter generation processing and key generation processing in advance (for example, before the use of the secure database 40) to generate Param and key=(OPEKey, MACKey, SymKey), respectively.

Assume, for example, that Message[1], . . . , Message[n] are input from the user who uses the encryption device 10 (or any program installed on the encryption device 10) to the encryption device 10 as messages to be registered in the secure database 40. Upon receiving such messages Message[1], . . . , Message[n], encryption means 203 may encrypt each message Message to calculate outputs Cipher[1]=(OPEPart[1], SymPart[1], MACPart[1]), . . . , Cipher[n]=(OPEPart[n], SymPart[n], MACPart[n]) and send them to the secure database 40. If, for example, encryption processing by the encryption means 203 is implemented as CipherGen(OPEParam, Key, Message), CipherGen(OPEParam, Key, Message[1]), . . . , CipherGen(OPEParam, Key, Message[n]) are executed to obtain outputs Cipher[1], . . . , Cipher[n], respectively. Enc( ) includes processing of invoking the encryption processing OPEPartGen(OPEParam, Message) according to the first exemplary embodiment, as described earlier. Cipher[i]. OPEPart indicates hereinafter OPEPart[i] included in Ciper[i].

The secure database 40 stores the received data in the data storage means 401. In this exemplary embodiment, each Cipher is stored in the format of (i, Cipher[i]). That is, the secure database 40 stores (1, Cipher[1]), . . . , (n, Cipher[n]) in the data storage means 401. A suffix i to Cipher[i] will be referred to as the ID of Cipher[i] or Message[i] hereinafter.

Assume, for example, that the user who uses the encryption device 10 (or any program installed on the encryption device 10) requires messages having values of M (inclusive) to M′ (inclusive) of the messages Message[ ] stored in the secure database 40. In such a case, the encryption device 10 calculates OPEPart_M=OPEPartGen(OPEParam, M) and OPEPart_M′=OPEPartGen(OPEParam, M′) and send OPEPart_M and OPEPart_M′ to the secure database 40 as data to be compared.

The size comparison means 402 of the secure database 40 outputs a list List of i that satisfies OPEPart_M≦Cipher[i]·OPEPart≦OPEPart_M′ from Cipher[1] through Cipher[n], as a retrieval result.

Because of the property of order-preserving encryption, the necessary and sufficient condition to satisfy M≦Message[i]≦M′ is given by OPEPart_M≦Cipher[i]·OPEPart≦OPEPart_M′. Hence, a list of i that satisfies M≦Message[i]≦M′ can be obtained by executing the above-mentioned protocol.

Based on the obtained list, the encryption device 10 decrypts Ciper[i] indicated by i included in the list to obtain a corresponding message. Assume, for example, that the list includes i=1, 3, 5. If decryption processing by the decryption means 204 is implemented as CipherDec(OPEParam, Key, Cipher), CipherDec(OPEParam, Key, Cipher[1]), CipherDec(OPEParam, Key, Cipher[3]), and CipherDec(OPEParam, Key, Cipher[5]) are executed to obtain outputs Message[1], Message[3], and Message[5], respectively.

As described above, the present invention allows a comparison between the sizes of data without decryption processing. Therefore, decryption processing can be performed upon narrowing of necessary data to decrypt and obtain data.

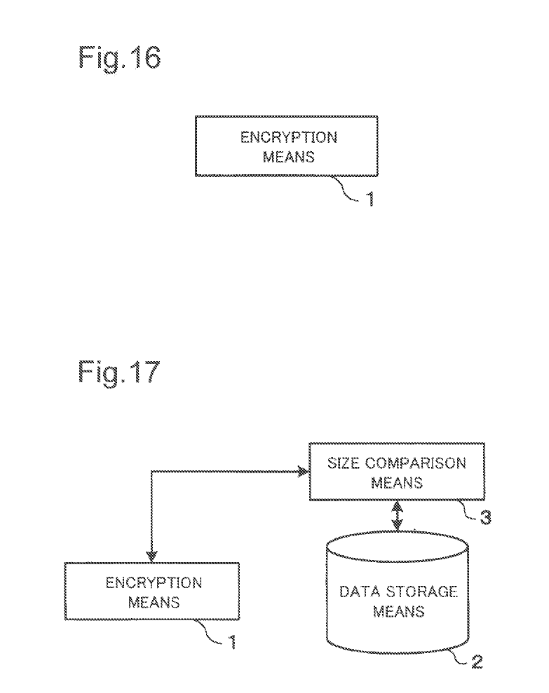

The minimum configuration of the order-preserving encryption system according to the present invention will be described below. FIG. 16 is a block diagram illustrating an exemplary minimum configuration of the order-preserving encryption system according to the present invention. The order-preserving encryption system includes encryption means 1 as a minimum component, as illustrated in FIG. 16.

In the order-preserving encryption system having the minimum configuration shown in FIG. 16, the encryption means 1, upon receiving a plaintext as input, generates an order-preserved cipher in accordance with a predetermined probability distribution generated based on values determined from the plaintext and on a set generated from a plaintext space included in a secret key using a uniform distribution, or a key to a predetermined pseudorandom function, the probability distribution representing a conditional probability as a binomial distribution.

The order-preserving encryption system having the minimum configuration allows order-preserving encryption with a simpler algorithm while ensuring security.

FIG. 17 is a block diagram illustrating an exemplary minimum configuration of the database system according to the present invention. The database system according to the present invention includes encryption means 1, data storage means 2, and size comparison means 3 as minimum components, as illustrated in FIG. 17.

In the database system shown in FIG. 17, the encryption means 1, upon receiving a plaintext as input, generates an order-preserved cipher OPEPart in accordance with a predetermined probability distribution generated based on values determined from the plaintext and on a set generated from a plaintext space included in a secret key using a uniform distribution, or a key to a pseudorandom function, the probability distribution representing a conditional probability as a binomial distribution.

The data storage means 2 stores the cipher OPEPart generated by the encryption means 1 as data.

The size comparison means 3 determines the size of the contents of the data stored in the data storage means 2 relative to an arbitrary plaintext M, by comparing the size of the data to be determined with a cipher OPEPart_M for the plaintext M having undergone order-preserving encryption by the encryption means 1.

The database system having the minimum configuration can improve data usability while ensuring data confidentiality.

Although the present invention has been described above with reference to exemplary embodiments, the present invention is not limited to the above-described exemplary embodiments. Various changes that would be understood by those skilled in the art can be made to the configurations and details of the present invention without departing from the scope of the present invention.

Some or all of the above-mentioned exemplary embodiments can also be described as in Supplementary notes but are not limited to the following description.

### (Supplementary Note 1)

An order-preserving encryption system comprising: encryption means for, upon receiving a plaintext as input, generating an order-preserved cipher in accordance with a predetermined probability distribution generated based on a value determined from the plaintext and on one of a set generated from a plaintext space included in a secret key using a uniform distribution and a key to a predetermined pseudorandom function, the probability distribution representing a conditional probability as a binomial distribution.

### (Supplementary Note 2)

The order-preserving encryption system according to supplementary note 1, further comprising: key generation means for generating a first set S comprising elements selected from a plaintext space uniformly at random and generating a second set L comprising a uniform random number as a function of the first set S to generate data comprising the first set S and the second set S as a secret key, wherein upon receiving a plaintext as input, based on the secret key, the encryption means calculates a count C″ of elements in the second set L corresponding to an element having a value of not more than a value MB determined from the plaintext, of the elements in the first set S to determine the count C″ as a first value that follows the predetermined probability distribution, calculates a count C′ determined from a count of elements in the plaintext space to determine the count C′ as a second value that follows the predetermined probability distribution, and adds the second value C′ to the first value C″ to generate an order-preserved cipher OPEPart.

### (Supplementary Note 3)

The order-preserving encryption system according to supplementary note 1, further comprising: key generation means for generating a key to a predetermined pseudorandom function as a secret key, wherein upon receiving a plaintext as input, based on the secret key, the encryption means calculates a value MB determined from the plaintext, obtains a value MBNum by a bisection method that defines the value MB as an accuracy of an approximate solution to determine the value MBNum as a first value that follows the predetermined probability distribution, and obtains a value MBVal by a bisection method that defines the first value MBNum as an accuracy of an approximation solution to determine the value MBVal as a second value that follows the predetermined probability distribution to generate an order-preserved cipher OPEPart using the second value MBVal, the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low, the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and the binomial distribution used for each of the bisection method that obtains the first value MBNum and the bisection method that obtains the second value MBVal is generated using a pseudorandom number obtained by inputting the secret key to the pseudorandom function.

### (Supplementary Note 4)

The order-preserving encryption system according to supplementary notes 2 or 3, wherein the key generation means generates not only the secret key but also a symmetric key for symmetric-key cryptography and a MAC key for a message authenticator, upon receiving a plaintext as input, the encryption means generates the order-preserved cipher OPEPart using the secret key, encrypts the plaintext by a symmetric encryption scheme using the symmetric key to generate a cipher SymPart, and adds a message authenticator MACPart generated using the MAC key to a complex cipher formed by a combination of the cipher OPEPart and the cipher SymPart to generate a cipher text Cipher, and the order-preserving encryption system further comprises: decryption means for, upon receiving the cipher text Cipher generated by the encryption means, reconstructing a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymPart using the symmetric key to obtain a plaintext.

### (Supplementary Note 5)

The order-preserving encryption system according to any one of supplementary notes 1 to 4, wherein letting p be a real number, the predetermined probability distribution takes 0 with a probability p and 1 with a probability 1−p.

### (Supplementary Note 6)

An encryption device comprising: encryption means for, upon receiving a plaintext as input, generating an order-preserved cipher in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution.

### (Supplementary Note 7)

The encryption device according to supplementary note 6, further comprising: key generation means for generating a first set S comprising elements selected from a plaintext space uniformly at random and generating a second set L comprising a uniform random number as a function of the first set S to generate data comprising the first set S and the second set S as a secret key, wherein upon receiving a plaintext as input, based on the secret key, the encryption means calculates a count C″ of elements in the second set L corresponding to an element having a value of not more than a value MB determined from the plaintext, of the elements in the first set S to determine the count C″ as a first value that follows the predetermined probability distribution, calculates a count C′ determined from a count of elements in the plaintext space to determine the count C′ as a second value that follows the predetermined probability distribution, and adds the second value C′ to the first value C″ to generate an order-preserved cipher OPEPart.

### (Supplementary Note 8)

The encryption device according to supplementary note 6, further comprising: key generation means for generating a key to a predetermined pseudorandom function as a secret key, wherein upon receiving a plaintext as input, based on the secret key, the encryption means calculates a value MB determined from the plaintext, obtains a value MBNum by a bisection method that defines the value MB as an accuracy of an approximate solution to determine the value MBNum as a first value that follows the predetermined probability distribution, and obtains a value MBVal by a bisection method that defines the first value MBNum as an accuracy of an approximation solution to determine the value MBVal as a second value that follows the predetermined probability distribution to generate an order-preserved cipher OPEPart using the second value MBVal, the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low, the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and the binomial distribution used for each of the bisection method that obtains the first value MBNum and the bisection method that obtains the second value MBVal is generated using a pseudorandom number obtained by inputting the secret key to the pseudorandom function.

### (Supplementary Note 9)

The encryption device according to supplementary notes 7 or 8, wherein the key generation means generates not only the secret key but also a symmetric key for symmetric-key cryptography and a MAC key for a message authenticator, upon receiving a plaintext as input, the encryption means generates the order-preserved cipher OPEPart using the secret key, encrypts the plaintext by a symmetric encryption scheme using the symmetric key to generate a cipher SymPart, and adds a message authenticator MACPart generated using the MAC key to a complex cipher formed by a combination of the cipher OPEPart and the cipher SymPart to generate a cipher text Cipher, and the order-preserving encryption system further comprises: decryption means for, upon receiving the cipher text Cipher generated by the encryption means, reconstructing a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymP art using the symmetric key to obtain a plaintext.

### (Supplementary Note 10)

The encryption device according to any one of supplementary notes 6 to 9, wherein letting p be a real number, the predetermined probability distribution takes 0 with a probability p and 1 with a probability 1−p.

### (Supplementary Note 11)

A database system comprising: encryption means for, upon receiving a plaintext as input, generating an order-preserved cipher OPEPart in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution; data storage means for storing the cipher OPEPart generated by the encryption means as data; and size comparison means for determining a size of a content of the data stored in the data storage means relative to an arbitrary plaintext M, wherein the size comparison means determines a size of the content of the data relative to an arbitrary plaintext M by comparing a size of the data to be determined with a cipher OPEPart_M for the plaintext M having undergone order-preserving encryption by the encryption means.

### (Supplementary Note 12)

The database system according to supplementary note 11, further comprising: key generation means for generating a first set S comprising elements selected from a plaintext space uniformly at random and generating a second set L comprising a uniform random number as a function of the first set S to generate data comprising the first set S and the second set S as a secret key, wherein upon receiving a plaintext as input, based on the secret key, the encryption means calculates a count C″ of elements in the second set L corresponding to an element having a value of not more than a value MB determined from the plaintext, of the elements in the first set S to determine the count C″ as a first value that follows the predetermined probability distribution, calculates a count C′ determined from a count of elements in the plaintext space to determine the count C′ as a second value that follows the predetermined probability distribution, and adds the second value C′ to the first value C″ to generate an order-preserved cipher OPEPart.

### (Supplementary Note 13)

The database system according to supplementary note 11, further comprising: key generation means for generating a key to a predetermined pseudorandom function as a secret key, wherein upon receiving a plaintext as input, based on the secret key, the encryption means calculates a value MB determined from the plaintext, obtains a value MBNum by a bisection method that defines the value MB as an accuracy of an approximate solution to determine the value MBNum as a first value that follows the predetermined probability distribution, and obtains a value MBVal by a bisection method that defines the first value MBNum as an accuracy of an approximation solution to determine the value MBVal as a second value that follows the predetermined probability distribution to generate an order-preserved cipher OPEPart using the second value MBVal, the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low, the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and the binomial distribution used for each of the bisection method that obtains the first value MBNum and the bisection method that obtains the second value MBVal is generated using a pseudorandom number obtained by inputting the secret key to the pseudorandom function.

### (Supplementary Note 14)

The database system according to supplementary notes 12 or 13, wherein the key generation means generates not only the secret key but also a symmetric key for symmetric-key cryptography and a MAC key for a message authenticator, upon receiving a plaintext as input, the encryption means generates the order-preserved cipher OPEPart using the secret key, encrypts the plaintext by a symmetric encryption scheme using the symmetric key to generate a cipher SymPart, and adds a message authenticator MACPart generated using the MAC key to a complex cipher formed by a combination of the cipher OPEPart and the cipher SymPart to generate a cipher text Cipher, and the order-preserving encryption system further comprises: decryption means for, upon receiving the cipher text Cipher generated by the encryption means, reconstructing a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymP art using the symmetric key to obtain a plaintext, the data storage means stores the cipher text Cipher generated by the encryption means as data, and the size comparison means determines a size of the content of the data relative to an arbitrary plaintext M by comparing a size of the cipher OPEPart reconstructed from the data to be determined with a cipher OPEPart_M for the plaintext M having undergone order-preserving encryption by the encryption means.

### (Supplementary Note 15)

The database system according to any one of supplementary notes 11 to 14, wherein letting p be a real number, the predetermined probability distribution takes 0 with a probability p and 1 with a probability 1−p.

### (Supplementary Note 16)

An order-preserving encryption method comprising: generating one of data including a set generated from a plaintext space using a uniform distribution and a key to a predetermined pseudorandom function to obtain a secret key; and upon receiving a plaintext as input, generating an order-preserved cipher in accordance with a predetermined probability distribution generated based on a value determined from the plaintext and on one of the set generated from the plaintext space included in the secret key using the uniform distribution and the key to the predetermined pseudorandom function, the probability distribution representing a conditional probability as a binomial distribution.

### (Supplementary Note 17)

The order-preserving encryption method according to supplementary note 16, further comprising: generating a first set S comprising elements selected from a plaintext space uniformly at random and generating a second set L comprising a uniform random number as a function of the first set S to generate data comprising the first set S and the second set S as a secret key; and upon receiving a plaintext as input, based on the secret key, calculating a count C″ of elements in the second set L corresponding to an element having a value of not more than a value MB determined from the plaintext, of the elements in the first set S to determine the count C″ as a first value that follows the predetermined probability distribution, calculating a count C′ determined from a count of elements in the plaintext space to determine the count C′ as a second value that follows the predetermined probability distribution, and adding the second value C′ to the first value C″ to generate an order-preserved cipher OPEPart.

### (Supplementary Note 18)

The order-preserving encryption method according to supplementary note 16, further comprising: generating a key to a predetermined pseudorandom function as a secret key; upon receiving a plaintext as input, calculating a value MB determined from the plaintext, based on the secret key; obtaining a value MBNum by a bisection method that defines the value MB as an accuracy of an approximate solution to determine the value MBNum as a first value that follows the predetermined probability distribution; and obtaining a value MBVal by a bisection method that defines the first value MBNum as an accuracy of an approximation solution to determine the value MBVal as a second value that follows the predetermined probability distribution to generate an order-preserved cipher OPEPart using the second value MBVal, wherein the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low, the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and the binomial distribution used for each of the bisection method that obtains the first value MBNum and the bisection method that obtains the second value MBVal is generated using a pseudorandom number obtained by inputting the secret key to the pseudorandom function.

### (Supplementary Note 19)

The order-preserving encryption method according to supplementary notes 17 or 18, further comprising: generating not only the secret key but also a symmetric key for symmetric-key cryptography and a MAC key for a message authenticator; upon receiving a plaintext as input, generating the order-preserved cipher OPEPart using the secret key, encrypting the plaintext by a symmetric encryption scheme using the symmetric key to generate a cipher SymPart, and adding a message authenticator MACPart generated using the MAC key to a complex cipher formed by a combination of the cipher OPEPart and the cipher SymPart to generate a cipher text Cipher; and upon receiving the cipher text Cipher, reconstructing a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymPart using the symmetric key to obtain a plaintext.

### (Supplementary Note 20)

The order-preserving encryption method according to any one of supplementary notes 16 to 19, wherein letting p be a real number, the predetermined probability distribution takes 0 with a probability p and 1 with a probability 1−p.

### (Supplementary Note 21)

An order-preserving encryption program for causing a computer to execute: processing of, upon receiving a plaintext as input, generating an order-preserved cipher in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution.

### (Supplementary Note 22)

The order-preserving encryption program according to supplementary note 21, for causing the computer to further execute: processing of generating a first set S comprising elements selected from a plaintext space uniformly at random and generating a second set L comprising a uniform random number as a function of the first set S to generate data comprising the first set S and the second set S as a secret key; and processing of, upon receiving a plaintext as input, based on the secret key, calculating a count C″ of elements in the second set L corresponding to an element having a value of not more than a value MB determined from the plaintext, of the elements in the first set S to determine the count C″ as a first value that follows the predetermined probability distribution, calculating a count C′ determined from a count of elements in the plaintext space to determine the count C′ as a second value that follows the predetermined probability distribution, and adding the second value C′ to the first value C″ to generate an order-preserved cipher OPEPart.

### (Supplementary Note 23)

The order-preserving encryption program according to supplementary note 21, for causing the computer to further execute: processing of generating a key to a predetermined pseudorandom function as a secret key; and processing of, upon receiving a plaintext as input, based on the secret key, calculating a value MB determined from the plaintext, obtaining a value MBNum by a bisection method that defines the value MB as an accuracy of an approximate solution to determine the value MBNum as a first value that follows the predetermined probability distribution, and obtaining a value MBVal by a bisection method that defines the first value MBNum as an accuracy of an approximation solution to determine the value MBVal as a second value that follows the predetermined probability distribution to generate an order-preserved cipher OPEPart using the second value MBVal, wherein the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low, the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and the binomial distribution used for each of the bisection method that obtains the first value MBNum and the bisection method that obtains the second value MBVal is generated using a pseudorandom number obtained by inputting the secret key to the pseudorandom function.

### (Supplementary Note 24)

The order-preserving encryption program according to supplementary notes 22 or 23, for causing the computer to further execute: processing of generating not only the secret key but also a symmetric key for symmetric-key cryptography and a MAC key for a message authenticator; processing of, upon receiving a plaintext as input, generating the order-preserved cipher OPEPart using the secret key, encrypting the plaintext by a symmetric encryption scheme using the symmetric key to generate a cipher SymPart, and adding a message authenticator MACPart generated using the MAC key to a complex cipher formed by a combination of the cipher OPEPart and the cipher SymPart to generate a cipher text Cipher; and processing of, upon receiving the cipher text Cipher, reconstructing a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymPart using the symmetric key to obtain a plaintext.

### (Supplementary Note 25)

The order-preserving encryption program according to any one of supplementary notes 21 to 24, wherein letting p be a real number, the predetermined probability distribution takes 0 with a probability p and 1 with a probability 1−p.

This application claims the benefit of priority based on Japanese Patent Application No. 2013-038238 filed on Feb. 28, 2013, the disclosure of which is hereby incorporated herein by reference in its entirety.

Although the present invention has been described above with reference to exemplary embodiments, the present invention is not limited to the above-described exemplary embodiments. Various changes that would be understood by those skilled in the art can be made to the configurations and details of the present invention without departing from the scope of the present invention.

### INDUSTRIAL APPLICABILITY

The present invention is suitably applicable to applications for which the sizes of data as encrypted are to be compared while ensuring data confidentiality. The present invention is, for example, applicable to secure databases.

### REFERENCE SIGNS LIST

1 encryption means
2 data storage means
3 size comparison means
10 encryption device
20 decryption device
30 key generation device
40 secure database
101, 201 parameter generation means
102, 202 key generation means
103, 203 encryption means
204 decryption means
401 data storage means
402 size comparison means
500 secure database system
37

1. An order-preserving encryption system comprising:
encryption unit configured to generate, upon receiving a plaintext as input, an order-preserved cipher in accordance with a predetermined probability distribution generated based on a value determined from the plaintext and on one of a set generated from a plaintext space included in a secret key using a uniform distribution and a key to a predetermined pseudorandom function, the probability distribution representing a conditional probability as a binomial distribution.

2. The order-preserving encryption system according to claim 1, further comprising:
key generation unit configured to generate a first set S comprising elements selected from a plaintext space uniformly at random and generating a second set L comprising a uniform random number as a function of the first set S to generate data comprising the first set S and the second set S as a secret key; wherein
upon receiving a plaintext as input, based on the secret key, the encryption unit calculates a count C″ of elements in the second set L corresponding to an element having a value of not more than a value MB determined from the plaintext, of the elements in the first set S to determine the count C″ as a first value that follows the predetermined probability distribution, calculates a count C′ determined from a count of elements in the plaintext space to determine the count C′ as a second value that follows the predetermined probability distribution, and adds the second value C′ to the first value C″ to generate an order-preserved cipher OPEPart.

3. The order-preserving encryption system according to claim 1, further comprising:
key generation unit configured to generate a key to a predetermined pseudorandom function as a secret key; wherein
upon receiving a plaintext as input, based on the secret key, the encryption unit calculates a value MB determined from the plaintext, obtains a value MBNum by a bisection method that defines the value MB as an accuracy of an approximate solution to determine the value MBNum as a first value that follows the predetermined probability distribution, and obtains a value MBVal by a bisection method that defines the first value MBNum as an accuracy of an approximation solution to determine the value MBVal as a second value that follows the predetermined probability distribution to generate an order-preserved cipher OPEPart using the second value MBVal,
the bisection method that obtains the first value MBNum uses a binomial distribution to calculate a value MidNum in a middle Mid between an upper limit High and a lower limit Low of the bisection method based on the upper limit High, the lower limit Low, and values HighNum and LowNum at the upper limit High and the lower limit Low,
the bisection method that obtains the second value MBVal uses a binomial distribution to calculate a value MidVal in a middle MidNum between an upper limit HighNum and a lower limit LowNum of the bisection method based on the upper limit HighNum, the lower limit LowNum, and values HighVal and LowVal at the upper limit HighNum and the lower limit LowNum, and
the binomial distribution used for each of the bisection method that obtains the first value MBNum and the bisection method that obtains the second value MBVal is generated using a pseudorandom number obtained by inputting the secret key to the pseudorandom function.

4. The order-preserving encryption system according to claim 2, wherein
the key generation unit generates not only the secret key but also a symmetric key for symmetric-key cryptography and a MAC key for a message authenticator,
upon receiving a plaintext as input, the encryption unit generates the order-preserved cipher OPEPart using the secret key, encrypts the plaintext by a symmetric encryption scheme using the symmetric key to generate a cipher SymPart, and adds a message authenticator MACPart generated using the MAC key to a complex cipher formed by a combination of the cipher OPEPart and the cipher SymPart to generate a cipher text Cipher, and
the order-preserving encryption system further comprises:
decryption unit configured to reconstruct, upon receiving the cipher text Cipher generated by the encryption unit, a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymPart using the symmetric key to obtain a plaintext.

5. The order-preserving encryption system according to claim 1, wherein letting p be a real number, the predetermined probability distribution takes 0 with a probability p and 1 with a probability 1−p.

6. An encryption device comprising:
encryption unit configured to generate, upon receiving a plaintext as input, an order-preserved cipher in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution.

7. A database system comprising:
encryption unit configured to generate, upon receiving a plaintext as input, an order-preserved cipher OPEPart in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution;
data storage unit configured to store the cipher OPEPart generated by the encryption unit as data; and
size comparison unit configured to determine a size of a content of the data stored in the data storage unit relative to an arbitrary plaintext M; wherein
the size comparison unit determines a size of the content of the data relative to an arbitrary plaintext M by comparing a size of the data to be determined with a cipher OPEPart_M for the plaintext M having undergone order-preserving encryption by the encryption unit.

8. The database system according to claim 7, further comprising:
encryption unit configured to generate, upon receiving a plaintext as input, an order-preserved cipher OPEPart in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution, encrypting the plaintext by a symmetric encryption scheme using a symmetric key to generate a cipher SymPart, and adding a message authenticator MACPart generated using a MAC key to a complex cipher formed by a combination of the cipher OPEPart and the cipher SymPart to generate a cipher text Cipher;
decryption unit configured to reconstruct, upon receiving the cipher text Cipher, a cipher OPEPart, a cipher SymPart, and a message authenticator MACPart from the cipher text Cipher, checking validity of the reconstructed message authenticator MACPart using the MAC key and a complex cipher formed by a combination of the reconstructed cipher OPEPart and the reconstructed cipher SymPart, and, when the reconstructed message authenticator MACPart is determined to be valid, decrypting the reconstructed cipher SymPart using the symmetric key to obtain a plaintext;
data storage unit configured to store the cipher text Cipher generated by the encryption unit as data; and
size comparison unit configured to determine a size of a content of the data stored in the data storage unit relative to an arbitrary plaintext M; wherein
the size comparison unit determines a size of the content of the data relative to an arbitrary plaintext M by comparing a size of the cipher OPEPart reconstructed from the data to be determined with a cipher OPEPart_M for the plaintext M having undergone order-preserving encryption by the encryption unit.

9. An order-preserving encryption method comprising:
generating one of data including a set generated from a plaintext space using a uniform distribution and a key to a predetermined pseudorandom function to obtain a secret key; and
upon receiving a plaintext as input, generating an order-preserved cipher in accordance with a predetermined probability distribution generated based on a value determined from the plaintext and on one of the set included in the secret key and the key to the predetermined pseudorandom function, the probability distribution representing a conditional probability as a binomial distribution.

10. An order-preserving encryption program for causing a computer to execute:
processing of, upon receiving a plaintext as input, generating an order-preserved cipher in accordance with a predetermined probability distribution generated based on a value determined from the plaintext and on one of a set generated from a plaintext space included in a secret key using a uniform distribution and a key to a pseudorandom function, the probability distribution representing a conditional probability as a binomial distribution.
